(19) United States
(12) Patent Application Publication
(10) Pub. No.: US 2003/0122357 A1
(43) Pub. Date: Jul. 3, 2003

(54) Magnetic tool holder

(76) Inventor: Jennifer C. Rhue, Ransomville, NY (US)

Correspondence Address: SIMPSON & SIMPSON, PLLC, 5555 MAIN STREET, WILLIAMSVILLE, NY, 14221-5406, US

(21) Appl. No.: 10/367,513

(22) Filed: Feb. 13, 2003

Related U.S. Application Data
(62) Division of application No. 09/798,340, filed on Mar. 2, 2001.

(51) Int. Cl. B60R 11/06

(52) U.S. Cl. 280/770

(57) ABSTRACT

A magnetic tool holder for a vehicle having a first layer having tool holder means attached thereto, a second uniformly magnetic layer, and a third layer operatively arranged to secure the first layer to the uniformly magnetic second layer. A second embodiment of the invention is a magnetic protective cover for a vehicle.

### CROSS REFERENCE TO RELATED APPLICATIONS

This United States Divisional Patent Application claims benefit pursuant to 35 U.S.C. §120 of U.S. Non-provisional patent application Ser. No. 09/798,340, filed on Mar. 2, 2001, which is currently co-pending and incorporated herein by reference.

### FIELD OF THE INVENTION

The present invention relates generally to tool holders and protective covers for vehicles, and, more particularly, to a magnetic tool holder and protective cover for a vehicle.

### BACKGROUND OF THE INVENTION

Tool holders in a variety of shapes and configurations, and made from a variety of materials, are well known in the art. Tool holders to assist mechanics and others working “under the hood” of a vehicle are similarly well known. Others have identified several problems encountered while working on a vehicle engine or other components under the hood of a vehicle. For example, anyone who has ever performed maintenance on a vehicle is familiar with the tendency of tools to fall through the open spaces under the hood and either become lost or lodged in some inaccessible space in the engine compartment, or to completely fall to the ground. No known vehicle provides a space under the hood for storage of tools during a repair. Moreover, tools tend to scratch or otherwise mar the finish of vehicles, particularly fenders, during repairs. It is little comfort to perfectly tune an engine, only to scratch the fender!

The obvious problem to be solved with tool holders for vehicles is to provide a means of attaching the tool holder to the vehicle in a location that provides easy and convenient access to the tools. In general, others have attached their tool holders to vehicles in one of two ways: magnetically or non-magnetically. Examples of non-magnetically attached tool holders are described in U.S. Pat. Nos. 250,926 (Perkins); 2,880,015 (Harben); 3,298,712 (Greenstadt); and 5,849,390 (Dillon).

Others teach the use of discrete magnets embedded or otherwise secured to a tool holder for the purpose of attaching the tool holder to a vehicle. For example, U.S. Pat. No. 5,460,305 (Ahearn) discloses a magnetic tool pouch having a soft, flexible fabric protective panel member and also has a plurality of magnets distributed therein to hold the panel member to the side of an automobile. Similar to the Hanel et al. patented invention, this device includes a plurality of discrete magnetic elements distributed around the perimeter of the tool pouch. The discrete magnets are actually embedded in the panel member. Again, this is a complicated and expensive article to manufacture, due to the embedding of the discrete magnets. Moreover, the magnetic flux emanating from the cover as a whole is not uniform (by “uniform”, the present patentee means that the magnetic flux emanating from the tool holder is substantially constant in strength when measured at any point across the surface of the holder. For example, a flux measurement taken two inches away from the holder at an edge thereof would be substantially the same as a measurement taken two inches away from the holder at the center of the holder, or at any point therebetween.) Covers and tool holders such as this which use discrete magnets such as this tend to travel, move and “bunch” as the mechanic rubs against it during the repair.

A related problem in protecting vehicle finishes is the vulnerability of our cars, trucks and other vehicles in general, and parking lots in particular, to collisions with shopping carts, doors of nearby vehicles, batted balls, running children, wind-blown objects, and the like. Who among us who has purchased a pristine new vehicle is not familiar with the discouragement felt when we discover that first “ding”, “knick” or scratch of the car's finish which, incidentally, usually seems to occur in a grocery or department store parking lot. Car doors seem to be especially vulnerable. How many of us have called our automobile insurance carriers to inquire about repairing the damage, only to find that the insurance deductible further discourages the repair. It is pretty well known that owners are often-times attached in difficult to explain emotional ways to their vehicles. We sometimes buy cars because we like the shape, the color, the shine, in addition to other features. We are sometimes particular about the appearance of our vehicles—witness the long lines at automated car washes during a break from bad weather. Thus, although we generally want to protect our vehicles from damage, we only want to do it in a way that is aesthetically pleasing. Shrouds and covers for vehicles are well known, but rare in application.

U.S. Pat. No. 4,849,272 (Haney et al.) discloses a fender cover (not a tool holder) made of a soft, non-abrasive first layer arranged to be disposed against a fender in an outer cover for protecting a fender while a mechanic works on an engine. The fender cover of this patented invention is held in place on the fender by means of flexible magnetic elements disposed between the two layers. With reference to the drawings of this patent, FIG. 1 shows the discrete magnetic elements 30, 32, 34, 36, 40 and 42. A problem with this design is that the magnets are disposed between the two layers of the fender cover. This is difficult and expensive to manufacture. Also, because discrete magnets are used, the magnetic flux emanating from the cover as a whole is not uniform. Hence, this patented invention does not solve the “bunching” problem described supra.

Emory discloses a fender cover in U.S. Pat. No. 5,919,541 having a soft resilient layer having one or two resilient non-porous layers attached to the top or bottom of the soft layer. The cover includes a plurality of spaced apart and linearly aligned magnets attached to the fender cover for holding the fender cover to a metal surface and for holding tools and other objects a technician or mechanic may need. Once again, this patent teaches discrete magnetic attachment means.

Crick discloses a magnetic fender cover in U.S. Pat. No. 5,799,975 having a sheet formed body with a plurality of magnets attached to the body. The crux of the Crick invention is that each of the magnets has an attachment face used to magnetically attach the body to an object and an opposed face substantially opposed to the attachment face. The opposed face of each one of the plurality of magnets is shielded to reduce magnetic flux adjacent to the opposed face, thereby increasing magnetic flux adjacent to the attachment face to each one of the plurality of magnets. This intricate design points out one of the problems with discrete magnet configurations—not enough magnetic flux to hold the cover to the vehicle! This patented device solves the problem by redirecting and shielding the flux.

What is needed, then, is a tool holder and protective cover for a vehicle which is uniformly securable to the vehicle and yet aesthetically pleasing to the eye.

### SUMMARY OF THE INVENTION

The present invention generally comprises a magnetic tool holder for a vehicle having a first layer with tool holder means attached thereto, a second uniformly magnetic layer, and a third layer operatively arranged to secure the first layer to the second uniformly magnetic second layer.

A second embodiment of the invention comprises a magnetic protective cover for a vehicle having a first layer, a second uniformly magnetic layer, and a third layer operatively arranged to secure the first layer to the second uniformly magnetic second layer. In a preferred second embodiment, the first layer of the protective layer is color-matched to the vehicle.

A general object of the invention is to provide a convenient and easy to use tool holder for a vehicle.

A further object is to provide a tool holder for a vehicle which includes a uniform magnetic layer operatively arranged to secure the tool holder to the vehicle.

Another object is to provide a protective cover for a vehicle which includes a uniform magnetic layer operatively arranged to secure the protective cover to the vehicle.

Still another object is to provide a protective cover for a vehicle which is color-matched to the vehicle.

These and other objects, features, and advantages will become apparent upon a reading of the detailed description of the invention in view of the claims and appended drawings.

### BRIEF DESCRIPTION OF THE DRAWINGS

The nature and mode of operation of the present invention will now be more fully described in the following detailed description of the invention taken with the accompanying drawing figures, in which:

FIG. 1 is a fragmentary perspective view of the magnetic tool holder embodiment of the invention, shown magnetically secured to a vehicle;

FIG. 2 is a perspective view of the magnetic tool holder of the invention;

FIG. 3 is a schematic plan view of the magnetic tool holder of the invention;

FIG. 4 is a fragmentary cross-sectional view of the magnetic tool holder of the invention, taken generally along line 4-4 of FIG. 3;

FIG. 5 is a fragmentary cross-sectional view of the magnetic tool holder of the invention, taken generally along line 5-5 of FIG. 3;

FIG. 6 is a fragmentary cross-sectional view of the magnetic tool holder of the invention, taken generally along line 6-6 of FIG. 3;

FIG. 7 is a fragmentary perspective view of the magnetic protective vehicle cover embodiment of the invention, shown magnetically secured to an exterior surface of a vehicle door;

FIG. 8 is a perspective view of the magnetic protective vehicle cover embodiment of the invention;

FIG. 9 is a fragmentary cross-sectional view of the magnetic protective vehicle cover embodiment of the invention, taken generally along line 9-9 of FIG. 8;

FIG. 10 is a cross-sectional view of a door of a vehicle, showing the magnetic protective vehicle cover embodiment of the invention secured thereto; and,

FIG. 11 is a view similar to that of FIG. 10, except showing the magnetic protective vehicle cover embodiment of the invention detached from a door of a vehicle to illustrate the uniform magnetic flux emanating from the cover.

### DETAILED DESCRIPTION OF THE PREFERRED EMBODIMENT

At the outset, it should be understood that like reference numerals on different drawing figures refer to identical structural elements.

The present invention generally comprises two embodiments, a first tool holder embodiment and a second protective cover embodiment. Both embodiments comprise three layers, and both embodiments have a uniformly magnetic layer operatively arranged to secure the tool holder/protective cover to a vehicle. By “uniformly magnetic” it is meant that the layer itself emanates substantially uniform magnetic flux across its entire surface area. A uniformly magnetic layer is distinctly different from prior art inventions that use discrete magnets embedded or otherwise secured between or within a layer of material.

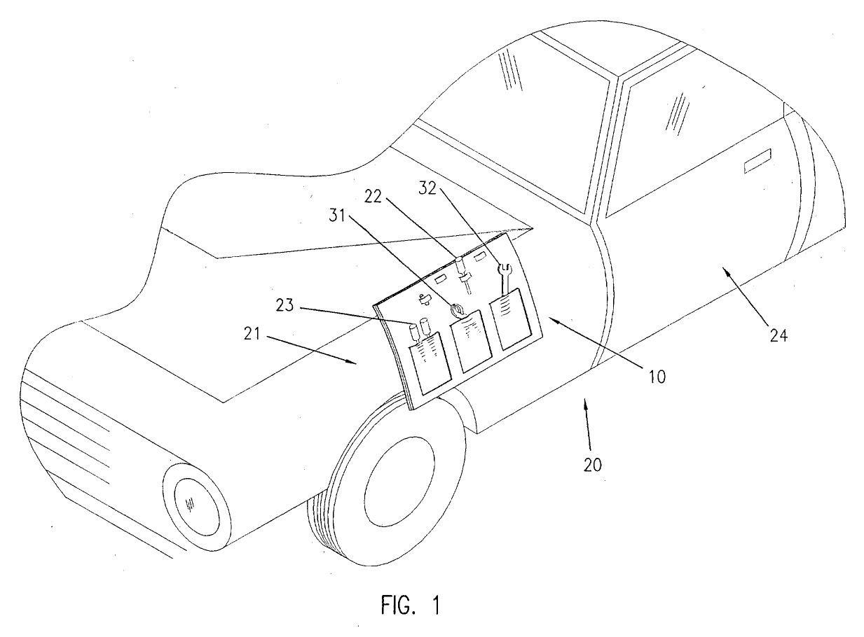

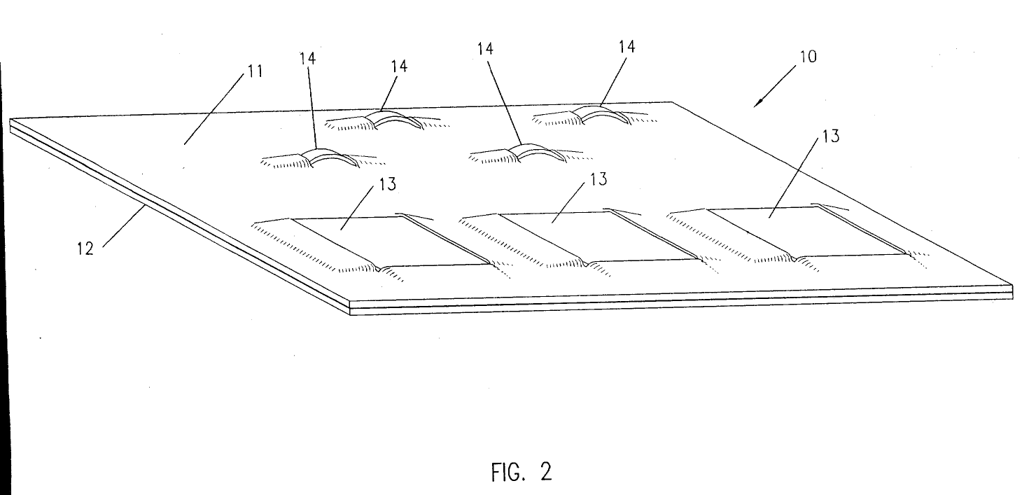

Adverting now to the drawings, FIG. 1 is a fragmentary perspective view of magnetic tool holder embodiment 10 of the invention, shown magnetically secured to vehicle 20. Magnetic tool holder 10 is shown magnetically secured to vehicle 20 at fender 21. It should be understood, however, that magnetic tool holder 10 can be secured to any surface of the vehicle that is magnetically attractive. In addition, magnetic tool holder 10 is shown holding various tools, including screwdrivers 22 and 23, pliers 31, and wrench 32. Obviously, the holder can hold a wide variety of tools. With reference to FIGS. 1 and 2, it is seen that the tool holder includes tool holder means comprising pouch 13 (shown holding screwdrivers 23 and wrench 32 in FIG. 1) and loop 14 (shown holding screwdriver 22 in FIG. 1). It should be appreciated that the tool holder of the present invention could also be used as a mat placed under the engine compartment of the vehicle, magnetic layer facing upward, to attract, catch and hold tools that may be dropped through the engine compartment to the ground.

Referring to FIG. 2 of the drawings; magnetic tool holder 10 comprises a first layer 11 that is arranged in substantial registration with second uniformly magnetic layer 12. Uniformly magnetic layer 12 functions to secure tool holder 10 to vehicle 20. By “substantial registration” it is meant that layers 11 and 12 substantially overlay and underlie one another in alignment with one another. It should be appreciated, however, that the appended claims are not intended to be so limited. For example, “substantial registration” is also intended to mean that one of the two layers may be smaller in surface area than the other. Moreover, the layers may be offset one from the other, as long as there is some substantial overlap. In a preferred embodiment, first layer 11 comprises a flexible, shock absorbing layer. Thus, in a preferred embodiment, first layer 11 may be made of neoprene rubber, such as that commercially available under the trade-name Open Cell Sponge Rubber, available from the Quick Cut Gasket & Rubber Corporation in Lancaster, N.Y. In a preferred embodiment, second uniformly magnetic layer 12 comprises a flexible magnetic material. In a preferred embodiment, the flexible magnetic material is magnetized rubber, such as that commercially available under the tradename ProMag and available from CMSB Magnetics in Middleport, N.Y. It should be understood, however, that other protective and magnetic materials may be used in the construction of the present invention, as long as the magnetic material produces a uniform magnetic field across the surface area of the second layer.

FIG. 3 is a schematic plan view of the magnetic tool holder of the invention.

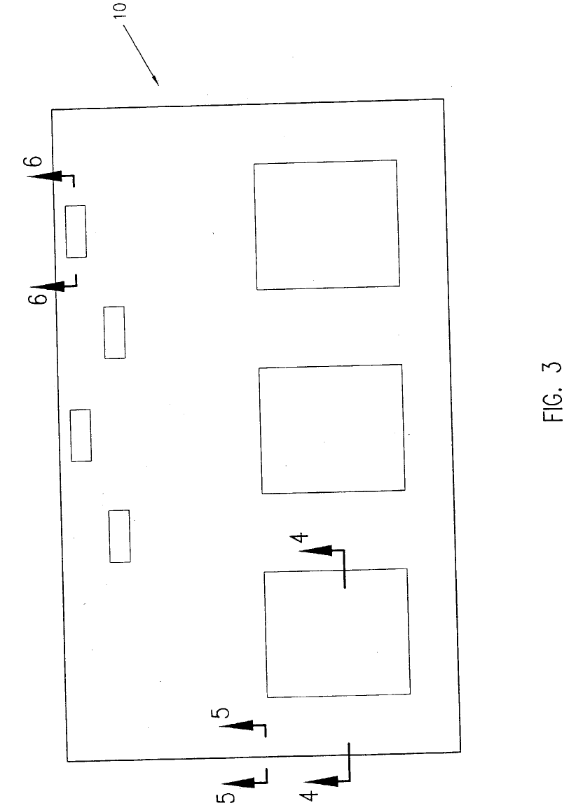

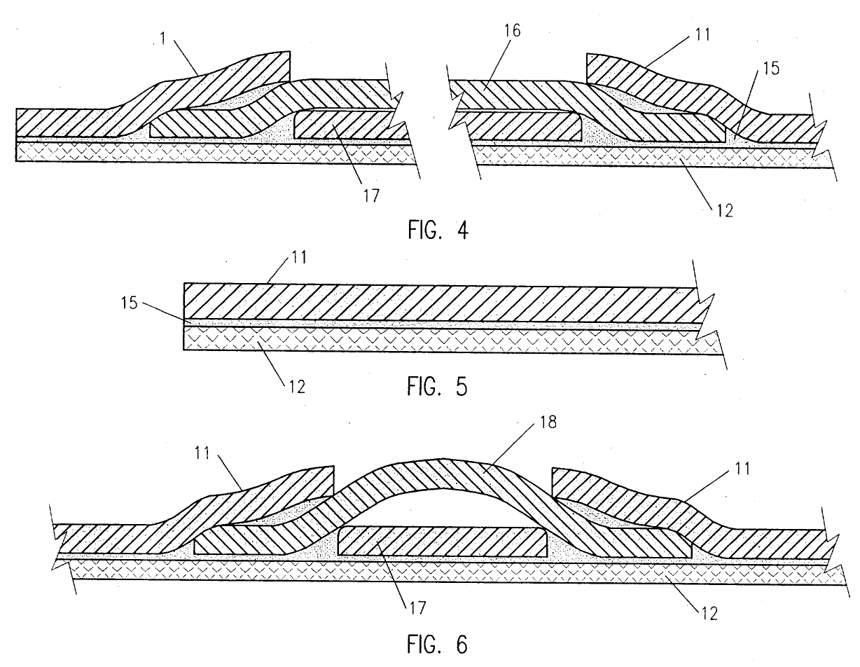

FIG. 4 is a fragmentary cross-sectional view of the magnetic tool holder of the invention, taken generally along line 4-4 of FIG. 3. This view clearly shows uniformly magnetic layer 12, first layer 11, and third flexible adhesive layer 15. As previously described, in a preferred embodiment, first layer 11 of the present invention comprises a protective rubber material commercially available under the trade name Open Cell Sponge Rubber and currently available from the Quick Cut Gasket and Rubber Corporation located in Lancaster, N.Y. In a preferred embodiment, second uniform magnetic layer 12 comprises a flexible rubber magnet material commercially available under the trade name ProMag and available from CMSB Magnetics in Middleport, N.Y. In a preferred embodiment, flexible adhesive layer 15 comprises a water-based adhesive available under the trade name #6046 Water-Based Contact Adhesive and available from Pioneer Adhesive in Orchard Park, N.Y. Again, it should be understood by those skilled in that art that materials having similar physical qualities and functionality are contemplated by the present invention as claimed. To make the subject invention, first layer 11 is secured to second uniformly magnetic layer 12 by means of the third adhesive layer 15.

Adverting now to FIG. 4, pouch 13 (shown in FIG. 2) is seen to comprise rubber pouch member 16, backing member 17, and first layer 11. Backing member 17 is secured to uniformly magnetic layer 12 with adhesive 15. Rubber member 16 which, in a preferred embodiment, is made of the same material as first layer 11, is shown wedged at two ends beneath first layer 11, which has been slit on three sides to accommodate pouch member 16, and is also secured at three ends to magnetic layer 12 by adhesive 15. It should be understood by those skilled in the art that the aforementioned attachment means are representative, but that those having ordinary skill in the art could readily imagine other means of attachment, including, but not limited to stitching, use of other adhesives, spot/heat welding, etc.

Adverting now to FIG. 6, loop 14 comprises first layer 11, second uniformly magnetic layer 12, flexible adhesive layer 15, loop member 18, and backing member 17. To form loop 14, first layer 11 is scored on a first and second side such that backing member 17 is formed and remains attached to first layer 11 on a third and fourth, non-scored side. Flexible adhesive, similar to that of adhesive layer 15, is then applied between first layer 11 and flap portions of loop layer 18 such that loop member 18 is secured to first layer 11. First layer 11, with secured loop member 18 and backing member 17, is then secured to magnetic layer 12 by means of flexible adhesive layer 15. Again, it should be understood by those skilled in the art that the aforementioned attachment means are representative, but that those having ordinary skill in the art could readily imagine other means of attachment, including, but not limited to: stitching, use of other adhesives, spot/heat welding, etc. Finally, it should be understood by those skilled in that art, that other attachment means and means to hold tools or other items, including, but not limited to: metallic or plastic snaps, hook and loop fasteners, metal loops, etc., are contemplated by the present invention.

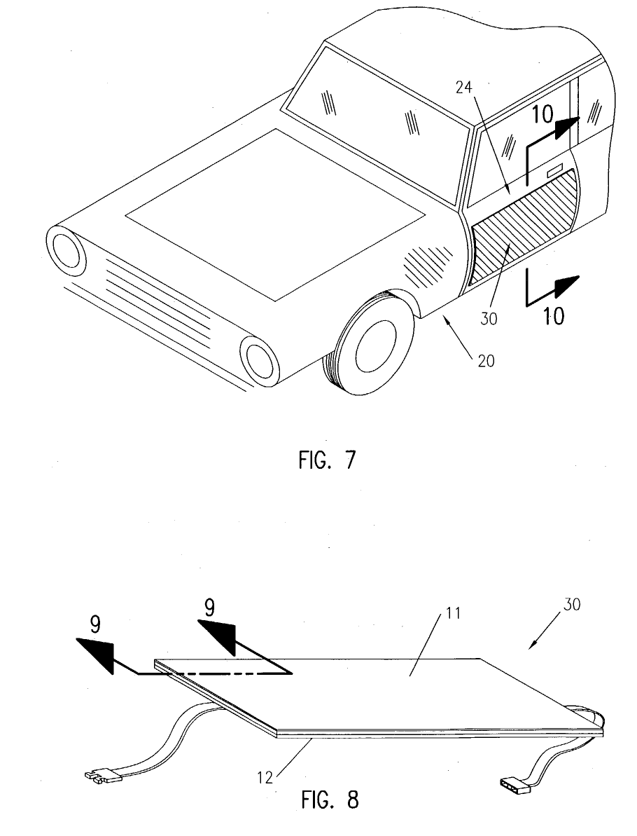

FIG. 7 is a fragmentary perspective view of magnetic protective vehicle cover embodiment 30 of the invention, shown magnetically secured to an exterior surface of vehicle door 24. In a preferred embodiment, protective cover 30 is of a color substantially similar or identical to that of vehicle 20 (as indicated by the cross-hatching in the drawing figure) and is magnetically secured to vehicle 20 at door 24. By “substantially similar”, it should be understood by those skilled in that art that the protective cover 30 has a general, aesthetically pleasing appeal that corresponds with the color of a vehicle, or part of a vehicle, to which it is intended to be attached. In other words, if the car is blue, the cover would be blue, although the shades may not match exactly (although in a preferred embodiment they would match exactly). In addition, it should be further understood by those skilled in that art that the preferred embodiment of the present invention also contemplates additional means of attaching and securing protective cover 30 to locations other than door 24 of vehicle 20; these means generally require the use of straps having coupling means.

FIG. 8 is a perspective view of the magnetic protective vehicle cover embodiment 30 of the invention. Cover 30 generally comprises first layer 11 and second uniformly magnetic layer 12. Protective cover 30 comprises a first layer 11 that is in substantial registration with second uniformly magnetic layer 12 and magnetically attaches protective cover 30 to a vehicle 20. While layers 11 and 12 maintain substantial registration with one another, meaning that layers 11 and 12 substantially overlay and underlie one another, it should be understood that either of layers 11 or 12 can be larger or smaller than the other. Also, one may overhang or overlay the other.

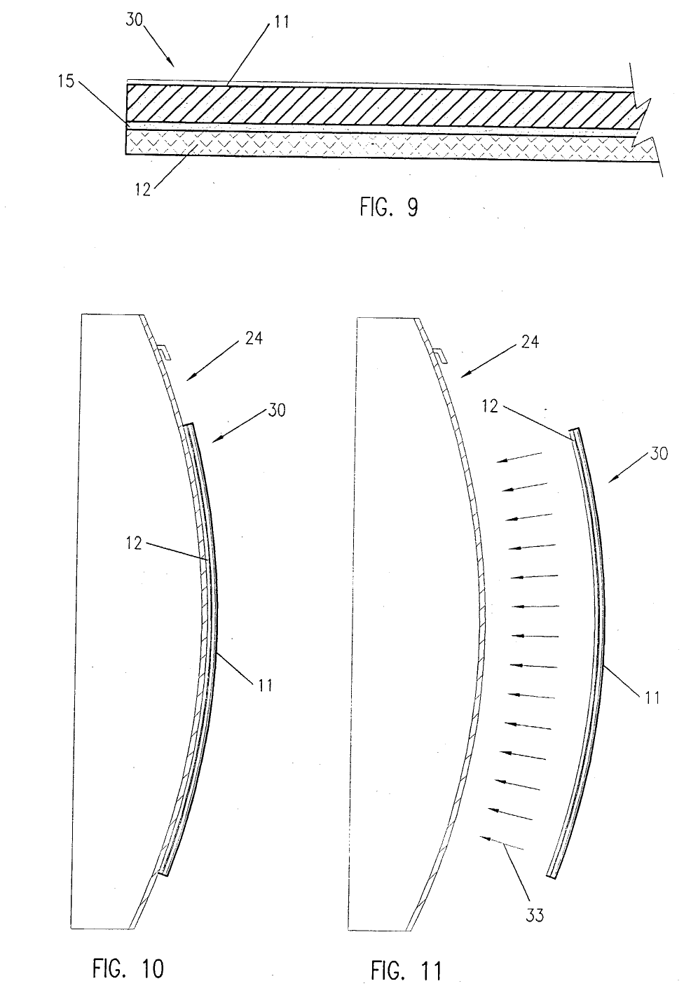

FIG. 9 is a fragmentary cross-sectional view of the magnetic protective vehicle cover embodiment of the invention, taken generally along line 9-9 of FIG. 8. Protective cover 30 comprises first layer 11, second uniformly magnetic layer 12, and adhesive layer 15 which secures the first layer to the second layer. In a preferred embodiment, first layer 11 is colored, either by painting, dyeing, injection molding, or by any other suitable process. In a preferred embodiment, the color of the first layer is selected to match the color of the vehicle to which the cover is intended to be applied. First layer 11 and second uniformly magnetic layer are secured to one another by means of adhesive layer 15.

FIG. 10 is a cross-sectional view of a door of a vehicle, showing the magnetic protective vehicle cover embodiment 30 of the invention secured thereto. Protective cover 30, flexibly attaches to a vehicle surface, such as a door 24, by the magnetic attractive means of the second uniformly magnetic layer 12. In addition, second uniformly magnetic layer 12 is flexible such that it conforms to the shape of a vehicle's surface.

FIG. 11 is a view similar to that of FIG. 10, except showing the magnetic protective vehicle cover embodiment of the invention detached from a door of a vehicle to illustrate the uniform magnetic flux emanating from the cover. In the drawing figure, the uniform magnetic flux is represented by flux lines 33. Since the flux and resulting magnetic field created by the second layer is uniform across substantially the entire surface area of the cover, the force of attachment of the cover to the vehicle is also uniform. This prevents the “bunching” or “slipping” of the cover described supra as a mechanic comes into contact with the cover during a repair.

Thus, it is seen that the objects of the invention are efficiently obtained, although modifications and changes to the invention will be readily apparent to those having ordinary skill in the art, and these changes and modifications are intended to fall within the scope of the invention as claimed.

What I claim is:

1. A magnetic tool holder for a vehicle comprising:
a first layer having tool holder means attached thereto;
a second uniformly magnetic layer; and,
a third layer operatively arranged to secure said first layer to said uniformly magnetic second layer.

2. The magnetic tool holder as recited in claim 1, wherein said first layer is made of sponge rubber.

3. The magnetic tool holder as recited in claim 1, wherein said second uniformly magnetic layer is made of rubber.

4. The magnetic tool holder as recited in claim 1, wherein said first and second layers are in substantial registration with one another.

5. The magnetic tool holder as recited in claim 1, wherein said third layer is flexible adhesive.

6. The magnetic tool holder as recited in claim 5, wherein said adhesive is water-based.

7. The magnetic tool holder as recited in claim 1, wherein said tool holder means is a member selected from the group consisting of pouches and loops.

8. The magnetic tool holder as recited in claim 7, wherein said pouches and loops are constructed of materials similar to said first layer.

9. In combination with a vehicle having a first color, a magnetic tool holder comprising:
a first layer having a second color similar to said first color, said first layer having tool holder means secured thereto.
a second uniformly magnetic layer; and
a third layer operatively arranged to secure said first layer to said second uniformly magnetic layer.

10. The magnetic tool holder as recited in claim 10, wherein said first layer sponge rubber.

11. The magnetic tool holder as recited in claim 10, wherein said second uniformly magnetic layer is rubber.

12. The magnetic tool holder as recited in claim 10, wherein said second uniformly magnetic layer has a planar surface and a substantially uniform magnetic flux about said planar surface.

13. The magnetic tool holder as recited in claim 10, wherein said third layer is flexible adhesive.

14. The magnetic tool holder as recited in claim 13, wherein said adhesive is water-based.

15. The magnetic tool holder as recited in claim 10, wherein said tool holder means is selected from the group consisting of pouches and loops.

16. The magnetic tool holder as recited in claim 15, wherein said pouches and loops are constructed from materials similar to said first layer.

17. A magnetic tool holder for a vehicle comprising:
a first sponge rubber layer having tool holder means attached thereto; said tool holder means comprising pouches and loops;
a second uniformly magnetic rubber layer; and,
a third adhesive layer operatively arranged to secure said first layer to said uniformly magnetic second layer.
